(19) United States
(12) Patent Application Publication
(10) Pub. No.: US 2007/0181854 A1
(43) Pub. Date: Aug. 9, 2007

(54) Advanced integration for improved integrated gasification combined cycle efficiency

(75) Inventors: Michael S. Briesch, Orlando, FL (US); Philip G. Deen, Enterprise, FL (US); Terrence B. Sullivan, Orlando, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/350,560

(22) Filed: Feb. 9, 2006

(51) Int. Cl. C01B 3/38

(52) U.S. Cl. 252/373; 423/650

(57) ABSTRACT

A system and method for increasing the efficiency and/or power produced by an integrated gasification combined cycle system by increasing the integration between the air separation unit island of the integrated gasification combined cycle system and the remainder of the system. By integrating one or more of the nitrogen and oxygen gas product streams from the air separation unit in the remainder of the integrated gasification combined cycle system, heat may be utilized that helps to increase the efficiency of the combustion reaction and/or the gasification reaction used to produce the syngas utilized in the system.

### FIELD OF THE INVENTION

The present invention is directed generally to gas turbine systems, and more particularly to integrated gasification combined cycle gas turbine systems.

### BACKGROUND OF THE INVENTION

The utilization of coal in the prior art has been minimized due to undesirable emissions, such as oxides of nitrogen and sulfur, particulate emissions and greenhouse gases such as carbon dioxide. As a result, there have been efforts to reduce these emissions and improve fuel efficiency of coal plants.

One of the systems that have been developed is the Integrated Gasification Combined Cycle (IGCC) system for use in power generation. IGCC systems were devised as a way to use coal as the source of fuel in a gas turbine plant. IGCC systems are clean and generally more efficient than prior art coal plants.

IGCC is a combination of two systems. The first system is coal gasification, which uses coal to create a clean-burning synthetic gas (“syngas”). The gasification portion of the IGCC plant produces syngas, which may then be used to fuel a combustion turbine. Coal is combined with oxygen in a gasifier to produce the syngas, hydrogen and carbon monoxide. The syngas may then be cleaned by a gas cleanup process. After cleaning, the syngas may be used in the combustion turbine to produce electricity.

The second system is a combined-cycle, or power cycle, which is an efficient method of producing electricity commercially. A combined cycle includes a combustion turbine/generator, a heat recovery steam generator (HRSG), and a steam turbine/generator. The exhaust heat from the combustion turbine may be recovered in the HRSG to produce steam. This steam then passes through a steam turbine to power another generator, which produces more electricity. A combined cycle is generally more efficient than conventional power generating systems because it re-uses waste heat to produce more electricity.

IGCC systems offer several advantages of IGCC over current conventional coal-based power generation systems. One advantage is reduced emissions. Another aspect of IGCC plants is that emissions clean-up, including removal of sulfur and carbon dioxide, may be effected upstream of the combustor system in the fuel stream. Since this stream is far smaller than the entire flue gas stream, emissions removal equipment for an IGCC plant are lower than for a conventional coal plant of like output.

IGCC systems offer other advantages, such as higher efficiency, less coal used, higher turbine outputs, and/or the production of additional chemical by-products, such as hydrogen, which may be used as an alternative source of energy in other developing technologies.

Nevertheless, IGCC systems may still suffer from reduced efficiencies as compared to other systems. Since syngas has a lower heating value than other fuels, more syngas is needed to produce a selected turbine temperature. In addition, the product nitrogen stream from the Air Separation Unit (ASU) Island of an Integrated Gasification Combined Cycle (IGCC) plant is at elevated temperatures, therefore requiring equipment for reducing the heat prior to venting.

Accordingly, it would be beneficial to provide a system that utilizes coal that has increased efficiencies as compared to prior art systems. It would also be beneficial to increase the integration of the components in the IGCC to increase efficiency and/or power out put of the IGCC systems.

### SUMMARY OF THE INVENTION

This present invention provides a method of increasing the efficiency and/or power produced by an integrated gasification combined cycle system by increasing the integration between the air separation unit island of the integrated gasification combined cycle system and the remainder of the system. By integrating one or more product streams from the air separation unit in the remainder of the integrated gasification combined cycle system, heat may be utilized that may have otherwise been lost or used further downstream in the system. The integration helps to increase the efficiency of the combustion reaction and/or the gasification reaction used to produce the syngas utilized in the integrated gasification combined cycle system.

In particular, in one aspect, the present invention provides a method for increasing efficiency of an integrated gasification combined cycle system including the steps of producing a nitrogen gas product stream and an oxygen gas product stream using an air separation unit, feeding the oxygen gas product stream to a gasifier, producing a syngas stream in the gasifier using the oxygen gas product stream and coal, and heating at least one of the nitrogen gas product stream, the oxygen gas product, or both using the syngas stream.

In another aspect, the present invention provides a system for increasing efficiency of an integrated gasification combined cycle system including an air separation unit for producing a nitrogen gas product stream and an oxygen gas product stream, a gasifier for producing a syngas stream in the gasifier using the oxygen gas product stream and coal, and a syngas cooler for cooling the syngas using at least a portion of at least one of the nitrogen gas product stream, the oxygen gas product, or both.

These and other embodiments are described in more detail below.

### BRIEF DESCRIPTION OF THE DRAWINGS

Other objects, features and advantages of the present invention will become apparent upon reading the following detailed description, while referring to the attached drawings, in which:

FIG. 1 shows a schematic of a standard IGCC system.

FIG. 2 shows a schematic of an IGCC system according to one embodiment of the present invention.

FIG. 3 shows a schematic of an IGCC system according to another embodiment of the present invention.

FIG. 4 shows a schematic of an IGCC system according to yet another embodiment of the present invention.

FIG. 5 shows a schematic of an IGCC system according to still another embodiment of the present invention.

FIG. 6 shows a schematic of an IGCC system according to yet another embodiment of the present invention.

FIG. 7 shows a schematic of an IGCC system according to still another embodiment of the present invention.

FIG. 8 shows a schematic of an IGCC system according to yet another embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

The present invention provides a method for increasing the efficiency of an integrated gasification combined cycle (IGCC) gas turbine system and an IGCC having increased efficiency. The present invention accomplishes the improved efficiency of the system by increasing the integration between the IGCC and the air separation unit (ASU) portion of the IGCC. In the present invention, heat from one area of the system is transferred and/or used in another area of the system to increase the overall efficiency of the system.

In one embodiment of the present invention, the improved integration utilizes one or more product gases from the ASU as part of a method for transferring heat from the IGCC system such that it may be used upstream in the IGCC system. For example, in one embodiment, one or more product gas streams may be used to heat the syngas entering the combustor. Since the excess heat is used and not wasted and/or the syngas enters the combustor at higher temperatures, the system operates at higher efficiencies than prior art systems. In addition, since the heat is recycled, less fuel may be used and/or more syngas may be generated, which may also increase the efficiency of the system.

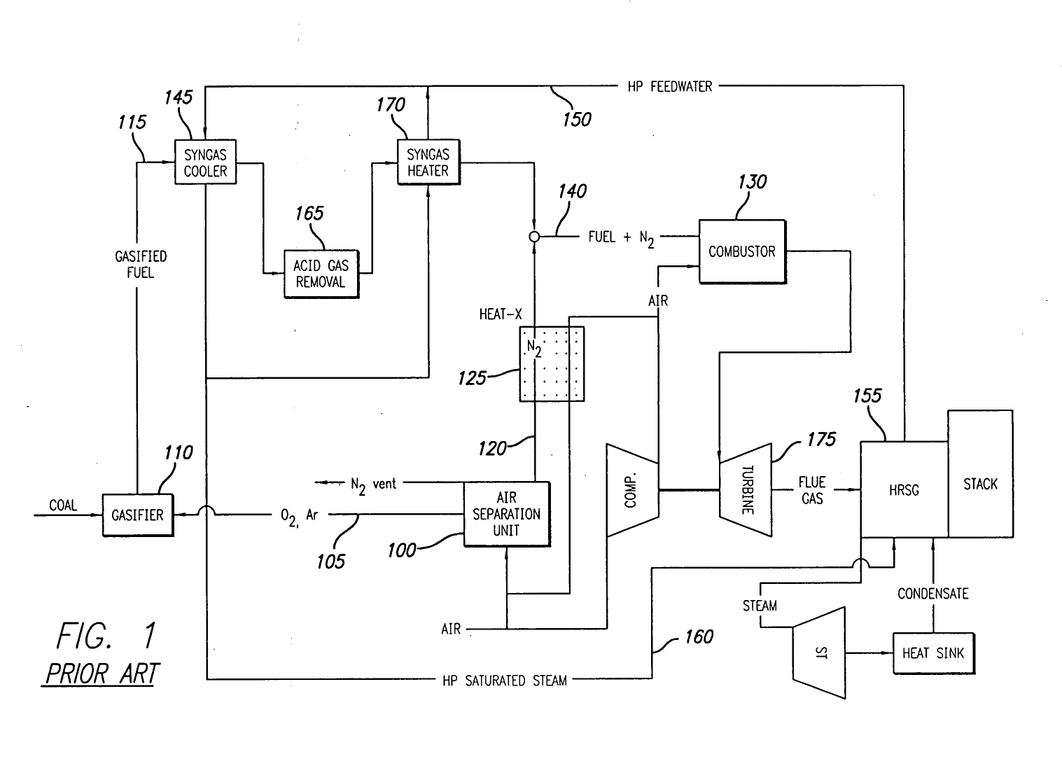

In a standard IGCC system, with reference to FIG. 1, the IGCC system includes an ASU 100, which produces an oxygen gas product stream 105 and a nitrogen gas product stream 120. In the present invention, the oxygen product stream 105 and/or the nitrogen product stream 120 are used to increase the efficiency of the IGCC system by integration of these product streams upstream in the system, to help transfer heat in the system, or by generating additional power.

In one aspect of the present invention, one or more product streams are used to transfer heat to the gasifier 110, which produces a synthetic gas (“syngas”) product stream 115, which may then be used as the fuel source for the combustor 130. The ASU 100, which may be a cryogenic ASU, is used to provide pure or substantially pure oxygen to the gasification reactor and, in alternative embodiments, may include a post-compression air bleed from the gas turbine 175. The ASU produces the oxygen gas product stream 105 and the nitrogen gas product stream 120, which are generally below the temperatures of other streams in the IGCC system, such as the syngas stream 115. As a result, the present invention utilizes one or more of these ASU product streams as heat sink sources, such that heat may be transferred to one or more other areas of the IGCC wherein the increased temperatures help to increase the efficiency of overall system.

Alternatively, or in addition thereto, the one or more gas product streams from the ASU may be used to transfer heat away from syngas, such as through the use of one or more syngas coolers 145. Since syngas must be cooled prior to being cleaned, cooling the syngas using the one or more product streams from the ASU increases the efficiency of the syngas cleaning and cooling process. The syngas is then cleaned in an acid gas removal stage 165. The syngas from the reactor is generally cleaned before it is used as a gas turbine fuel. The cleanup process typically involves removing sulfur compounds, ammonia, metals, alkalytes, ash, and/or particulates to meet the gas turbine's fuel gas specifications. The syngas may then be heated in a syngas heater 170 before being used in the combustor 130.

The one or more product streams may also be used to increase the heat of the fuel mixture 140 that enters into the combustor 130. For example, in one embodiment, the nitrogen gas product stream may be used to dilute the syngas stream to achieve a selected heating value of the fuel mixture 140 entering the combustor. In a standard IGCC system, the nitrogen gas product stream 120, if used to dilute the fuel mixture 140, may first be passed through a heat exchanger 125 which is used to heat the nitrogen stream 120 since the product streams from the ASU 100 are typically at cooler temperatures since most air separation process are performed at sub-zero temperatures. In select embodiments, the nitrogen product stream 120 may be further heated, with the heat then being used in the combustor 130 to increase the efficiency of the system.

Accordingly, by using one or more product streams from the ASU as a means to utilize heat that would otherwise be lost and/or used downstream, the present invention increases the efficiency of the IGCC system by increasing the amount of syngas created per unit of coal feedstock supplied, by increasing the temperature of the fuel mixture, and/or by increasing the amount of power generated by the system. These concepts may be accomplished using a variety of embodiments.

In one embodiment, product nitrogen (N₂) gas that is generated from the Air Separation Unit (ASU) is routed to a heat exchanger where it is heated by the syngas that is produced in the gasifier. After leaving this heat exchanger, the heated nitrogen is mixed with the fuel stream and the mixture enters the combustor of the gas turbine. The syngas is cooled in the heat exchanger. In this embodiment, a portion of the ASU nitrogen product gas may be routed through the heat exchanger; however, it is also contemplated that, in an alternative embodiment, the entire product nitrogen gas stream could be routed in this manner.

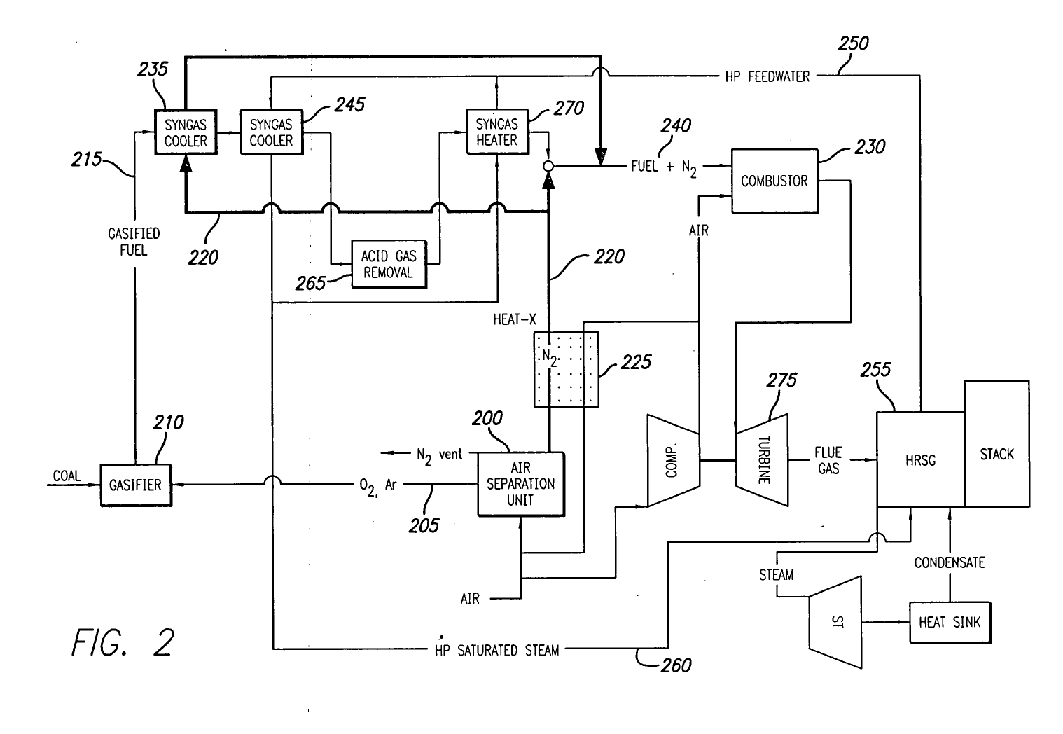

FIG. 2 provides a schematic of this embodiment. As shown, the ASU 200 includes an oxygen gas product stream 205 that may be sent to the gasifier 210 for use in forming the syngas product stream 215. The nitrogen product gas stream 220 from the ASU 200 may then be passed through a heat exchanger 225 to heat the nitrogen gas 220. Instead of then being mixed with the syngas to then be fed into the combustor 230, as with prior art IGCC systems, this embodiment diverts all or a part of the nitrogen gas stream 220 to a first syngas cooler 235, wherein heat from the syngas 215 may be transferred to the nitrogen gas 220, which may then be mixed with the syngas to form the fuel mixture 240 that then enters the combustor 230. Since the syngas is normally cooled to help permit acid gases to be removed, the excess heat, instead of being lost, may now be used to heat the fuel mixture 240 entering the combustor 230, thereby increasing the efficiency of the system. This embodiment may include a syngas cooler 245, which uses feedwater 250 from the HRSG 255 to form steam 260 that may be used to generate power in the HRSG; an acid gas removal stage 265; and a syngas heater 270. Combustion products from the combustor 230 may be sent to gas turbine 275 to produce power, and since the fuel mixture 240 is at a higher temperature, the temperature of the combustion products is higher, thereby producing more power in the turbine.

In an alternative embodiment, product nitrogen (N₂) gas generated from the ASU is mixed with the syngas that is produced in the gasifier, such as through using a mixing valve. The nitrogen stream enters at a much colder temperature than the syngas, resulting in a cooler mixed fuel stream temperature entering the syngas cooler. In this embodiment, a portion of the ASU nitrogen product gas may be routed to the syngas stream; however, it is also contemplated that, in an alternative embodiment, the entire product nitrogen gas stream could be routed in this manner.

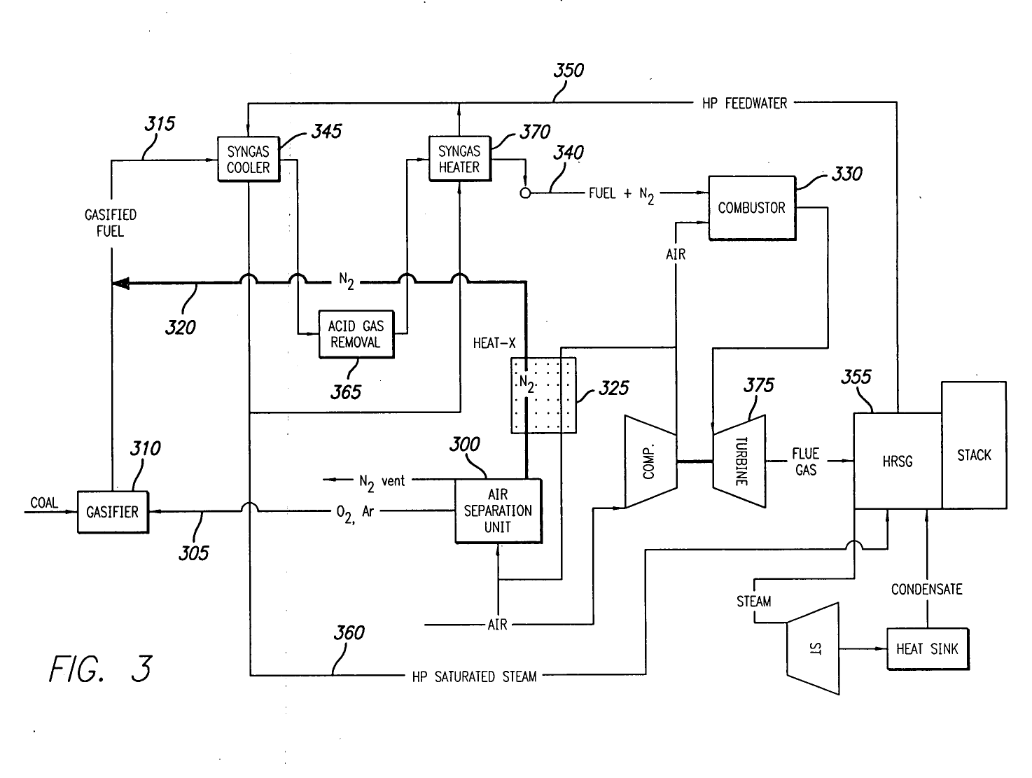

FIG. 3 provides a schematic of this embodiment. As shown, the ASU 300 includes an oxygen gas product stream 305 that may be sent to the gasifier 310 for use in forming the syngas product stream 315. The nitrogen product gas stream 320 from the ASU 300 may then be passed through a heat exchanger 325 to heat the nitrogen gas 320. Instead of then being mixed with the syngas just prior to being fed into the combustor 330, this embodiment diverts all or a part of the nitrogen gas stream 320 such that it may be mixed with the syngas stream 315, thereby cooling the syngas 315. Since the syngas is cooled, less heat is needed to cool the mixture in the syngas cooler 345. The stream may then pass through an acid gas removal stage 365 and heater 370 and then enter the combustor 330. This embodiment may use feedwater 350 from the HRSG 355 to form steam 360 that may be used to generate power in the HRSG. Combustion products from the combustor 330 may be sent to gas turbine 375 to produce power.

In yet another alternative embodiment, product nitrogen gas generated from the ASU is mixed with the syngas that is produced in the gasifier, such as through use of a mixing valve. The nitrogen stream enters at a much colder temperature than the syngas, resulting in a mixed fuel stream temperature that can be accepted by the cold gas clean-up system, thus obviating the need for a syngas cooler. In this embodiment, a portion of the ASU nitrogen product gas may be routed to the syngas stream; however, it is also contemplated that, in an alternative embodiment, the entire product nitrogen gas stream could be routed in this manner.

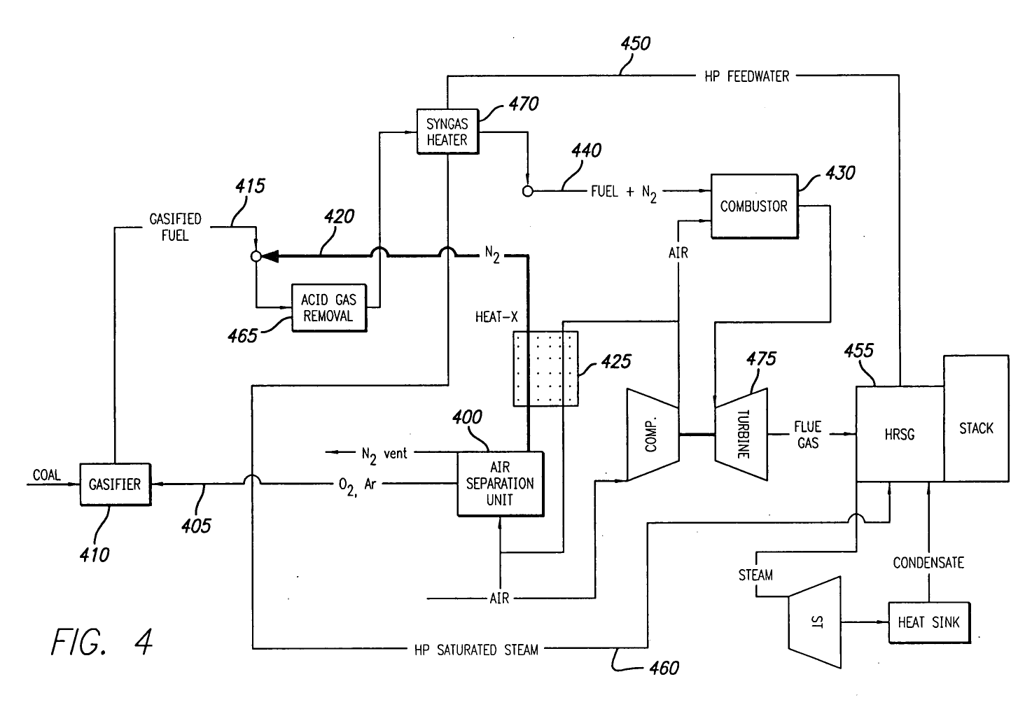

FIG. 4 provides a schematic of this embodiment. As shown, the ASU 400 includes an oxygen gas product stream 405 that may be sent to the gasifier 410 for use in forming the syngas product stream 415. The nitrogen product gas stream 420 from the ASU 400 may then be passed through a heat exchanger 425 to heat the nitrogen gas 420. Instead of then being mixed with the syngas just prior to being fed into the combustor 430, this embodiment diverts all or a part of the nitrogen gas stream 420 such that it may be mixed with the syngas stream 415, thereby cooling the syngas 415. Unlike the embodiment described in FIG. 3, since the syngas may be cooled with the nitrogen gas, no syngas cooler is used. As such, the nitrogen gas/syngas stream may be passed directly into an acid gas removal stage 465 and then a heater 470 and then may be sent to the combustor 430 as a fuel mixture 440. This embodiment may also use feedwater 450 from the HRSG 455 in the syngas heater 470 to form steam 460 that may be used to generate power in the HRSG. As with the other embodiments, combustion products from the combustor 430 may be sent to gas turbine 475 to produce power.

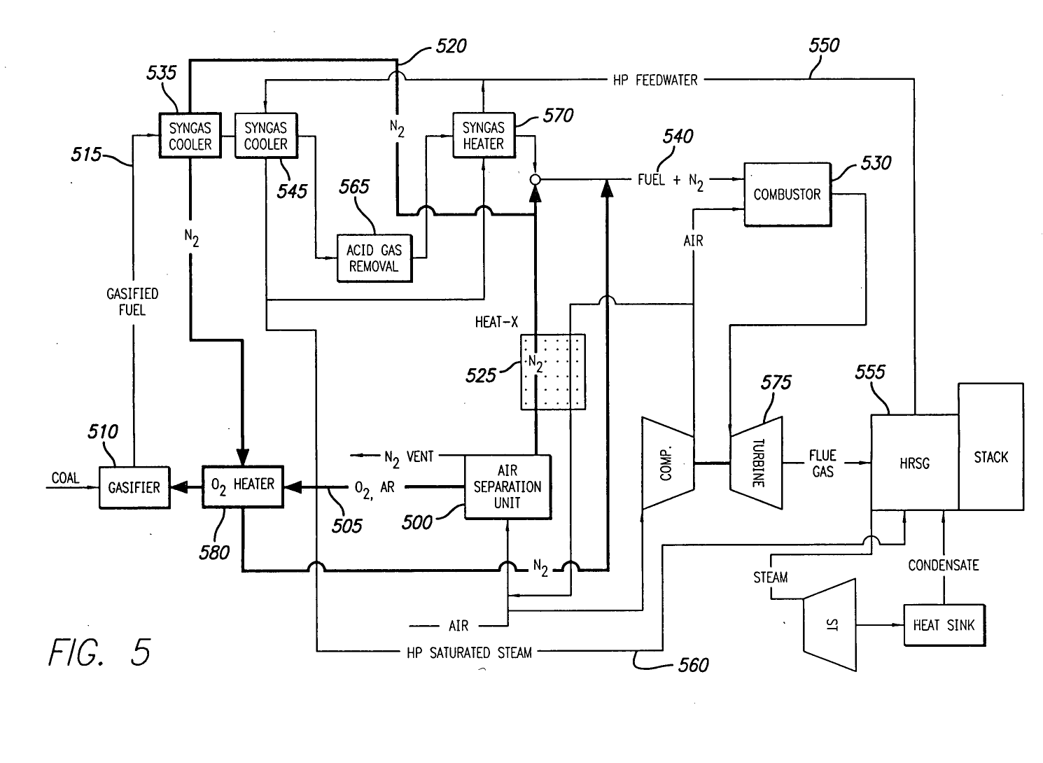

In still another embodiment, the product nitrogen gas stream generated from the ASU is routed to a heat exchanger where it is heated by the syngas that is produced in the gasifier. The heated nitrogen stream is then routed to a heat exchanger where it is cooled by the oxygen stream produced in the ASU. As with the previous embodiments, all or a portion of the ASU product nitrogen stream may be routed through the heat exchanger. In addition, it is possible that only a portion of the oxygen leaving the ASU will be heated prior to entering the gasifier. As shown in FIG. 5, a first syngas cooler, such as the one described in FIG. 1, may be used downstream of the nitrogen stream heater. However, in an alternative embodiment, it is possible that this cooler would not be used.

FIG. 5 provides a schematic of this embodiment. As shown, the ASU 500 includes an oxygen gas product stream 505 that may be sent to the gasifier 510 for use in forming the syngas product stream 515. The nitrogen product gas stream 520 from the ASU 500 may be passed through a heat exchanger 525 to heat the nitrogen gas 520. Instead of then being mixed with the syngas to then be fed into the combustor 530, this embodiment diverts all or a part of the nitrogen gas stream 520 to a first syngas cooler 535, wherein heat from the syngas 515 may be transferred to the nitrogen gas 520. The heated nitrogen gas may then be sent to an oxygen heater 580 that heats the oxygen prior to entering the gasifier 510. By increasing the temperature of the oxygen, the efficiency of the gasifier 510 may be increased, thereby increasing the amount of syngas generated per unit of coal used as feedstock. The nitrogen stream may then be mixed with the syngas to form the fuel mixture 540 that then enters the combustor 530. As discussed, this embodiment may include a second syngas cooler 545, which uses feedwater 550 from the HRSG 555 to form steam 560 that may be used to generate power in the HRSG; an acid gas removal stage 565; and a syngas heater 570. Combustion products from the combustor 530 may be sent to gas turbine 575 to produce power.

In yet another embodiment, which is related to the previous embodiment, product nitrogen gas from the ASU may be routed to a heat exchanger where it may be heated by the syngas that is produced in the gasifier. The heated nitrogen stream may then be routed to a heat exchanger where it may be cooled by the oxygen stream produced in the ASU. After leaving this heat exchanger, the nitrogen stream may be fed into another heat exchanger where it is re-heated by the syngas before being mixed with the syngas. As with previous embodiments, all or a portion of the nitrogen gas stream may be routed. Also, in an alternative embodiment, only a portion of the oxygen leaving the ASU may be heated prior to entering the gasifier.

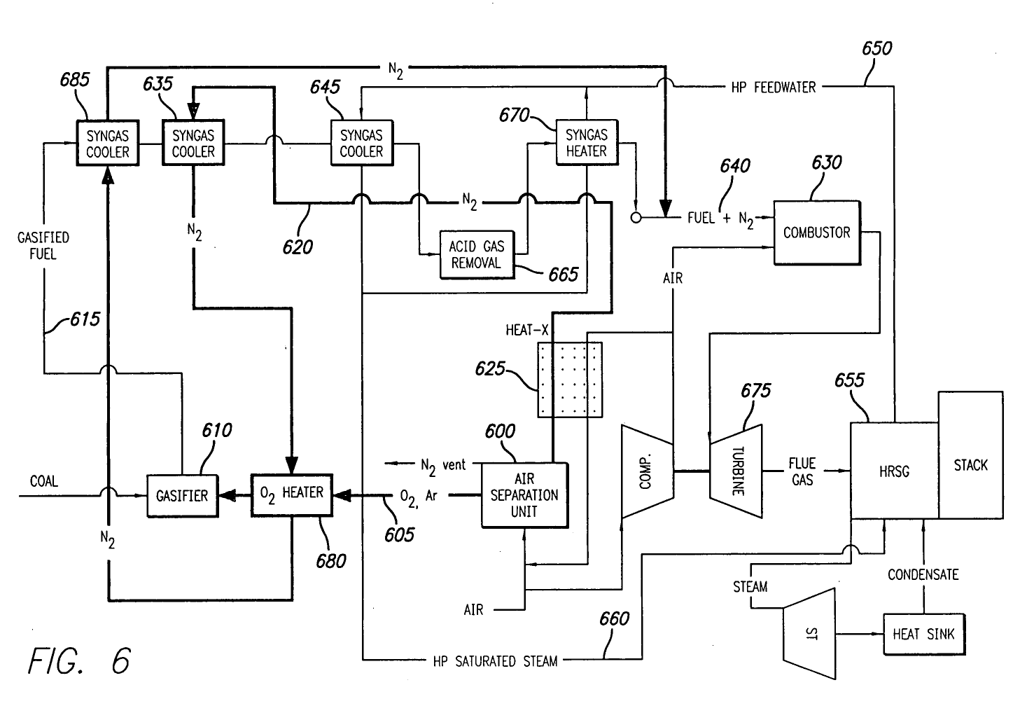

FIG. 6 provides a schematic of this embodiment. As shown, the ASU 600 includes an oxygen gas product stream 605 that may be sent to the gasifier 610 for use in forming the syngas product stream 615. The nitrogen product gas stream 620 from the ASU 600 may then be passed through a heat exchanger 625 to heat the nitrogen gas 620. Instead of then being fed into the combustor 630 with the fuel, this embodiment diverts all or a part of the nitrogen gas stream 620 to a syngas cooler 635, wherein heat from the syngas 615 may be transferred to the nitrogen gas 620. The heated nitrogen gas may then be sent to an oxygen heater 680 that heats the oxygen prior to entering the gasifier 610. As previously discussed, by increasing the temperature of the oxygen, the efficiency of the gasifier 610 is increased, thereby increasing the amount of syngas generated per unit of coal used as feedstock. The nitrogen stream 620 may then be used to cool the syngas 615 using another syngas cooler 685 prior to being mixed with the syngas to form the fuel mixture 640 that then enters the combustor 630. Alternatively, as with the embodiments described in FIGS. 3 and 4, the nitrogen gas stream 620 may be mixed with the syngas stream directly, such as through a mixing valve. As discussed, this embodiment may include another syngas cooler 645, which uses feedwater 650 from the HRSG 655 to form steam 660 that may be used to generate power in the HRSG; an acid gas removal stage 665; and a syngas heater 670. Combustion products from the combustor 630 may be sent to gas turbine 675 to produce power. It is to be understood, however, that in alternative embodiments, the syngas cooler 685 may be located downstream of the syngas cooler 635, rather than upstream. In addition, syngas cooler 685 may be removed and the nitrogen stream 620 may be mixed with the syngas stream 615 prior to entering syngas cooler 635 or syngas cooler 645.

In still another embodiment, the nitrogen product gas from the ASU is not used and is mixed with the syngas prior to combustion. In this embodiment, however, product oxygen gas generated from the ASU is routed directly to a heat exchanger where it is heated by the syngas that is produced in the gasifier, effecting simultaneous cooling of the gasifier product syngas and heating of the gasifier oxygen feed stream. Again, since the syngas is cooled prior to being cleaned, the cleaning process is more efficient. And since the oxygen gas is heated, the gasification process is more efficient.

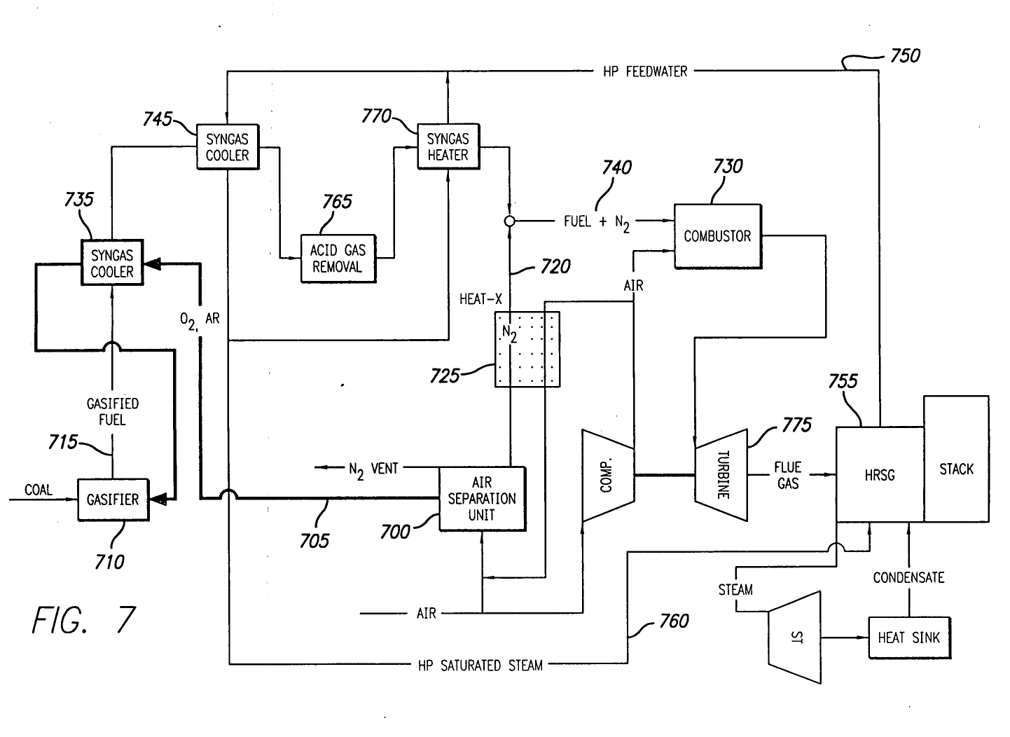

FIG. 7 provides a schematic of this embodiment. As shown, the ASU 700 includes an oxygen gas product stream 705 that is sent to the gasifier 710 for use in forming the syngas product stream 715. The nitrogen product gas stream 720 from the ASU 700 may be passed through a heat exchanger 725 to heat the nitrogen gas 720 which is then mixed with the syngas and fed into the combustor 730 as a fuel mixture 740. All or a portion of the oxygen gas product stream 705 is used in a first syngas cooler 735, wherein heat from the syngas 715 is transferred to the oxygen gas 705, which is then used in the gasifier 710. This embodiment includes a second syngas cooler 745, which uses feedwater 750 from the HRSG 755 to form steam 760 that is used to generate power in the HRSG 755; an acid gas removal stage 765; and a syngas heater 770. Combustion products from the combustor 730 are sent to gas turbine 775 to produce power.

In yet another embodiment, the present invention utilizes a product stream from the ASU not as a source of heat transfer throughout the system, but as a source of additional power. In one embodiment, the product nitrogen stream is used as an additional source of power. In this embodiment, excess nitrogen that would normally be vented from the ASU is instead routed to a turbine, where it is expanded down to ambient pressure to generate torque for power generation, driving a compressor, or some other application. If the nitrogen stream is at an elevated temperature, then, in one embodiment, it may be routed through the HRSG with the flue gas. In an alternative embodiment, it may be vented to atmosphere.

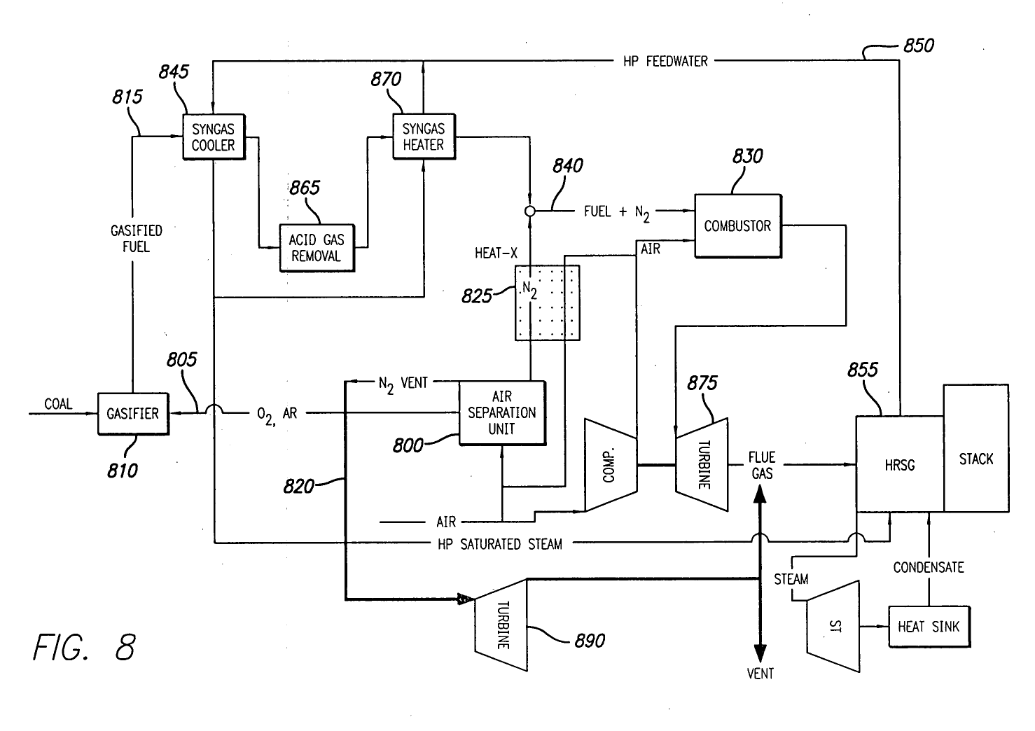

FIG. 8 provides a schematic of this embodiment. As shown, the ASU 800 includes an oxygen gas product stream 805 that is sent to the gasifier 810 for use in forming the syngas product stream 815. A nitrogen product gas stream 820 from the ASU 800, which in previous embodiments may be passed through a heat exchanger 825, may, instead, be expanded through a separate turbine 890 to produce additional power. As with other embodiments, all or a portion of the nitrogen gas product stream 820 may be sent to the turbine 890 while another portion is passed through the heat exchanger 825 and mixed with the syngas 815 to form the fuel mixture 840 which is introduced to the combustor 830.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A method for increasing efficiency of an integrated gasification combined cycle system comprising the steps of:
producing a nitrogen gas product stream and an oxygen gas product stream using an air separation unit;
feeding the oxygen gas product stream to a gasifier;
producing a syngas stream in the gasifier using the oxygen gas product stream and coal; and
heating at least a portion of at least one of the nitrogen gas product stream, the oxygen gas product, or both using the syngas stream.

2. The method of claim 1, wherein the nitrogen gas product stream is heated by the syngas stream using a syngas heat exchanger.

3. The method of claim 2, further comprising the step of mixing the heated nitrogen gas product stream with the syngas stream prior to combustion of the syngas stream in a combustor.

4. The method of claim 1, wherein the nitrogen gas product stream is heated by the syngas stream by mixing the syngas stream and the nitrogen gas product stream before the mixture is passed through the syngas cooler.

5. The method of claim 1, wherein the nitrogen gas product stream is heated by the syngas stream using a syngas heat exchanger and wherein the oxygen gas product stream is heated by the heated nitrogen gas product stream in an oxygen heat exchanger prior to being used in the gasifier.

6. The method of claim 5, further comprising the step of mixing the nitrogen gas product stream with the syngas stream prior to combustion of the syngas stream in a combustor.

7. The method of claim 5, further comprising the step of reheating the nitrogen gas product stream using a second syngas heat exchanger.

8. The method of claim 1, wherein the oxygen gas product stream is heated by the syngas stream using a syngas heat exchanger.

9. A system for increasing efficiency of an integrated gasification combined cycle system comprising:
an air separation unit for producing a nitrogen gas product stream and an oxygen gas product stream;
a gasifier for producing a syngas stream in the gasifier using the oxygen gas product stream and coal; and
a syngas cooler for cooling the syngas using at least a portion of at least one of the nitrogen gas product stream, the oxygen gas product, or both.

10. The system of claim 9, wherein the syngas cooler is a syngas heat exchanger for cooling the syngas using the nitrogen gas product stream.

11. The system of claim 9, wherein the syngas cooler is a mixing valve for mixing the syngas stream and the nitrogen gas product stream.

12. The system of claim 9, wherein the syngas cooler is a syngas heat exchanger for cooling the syngas using the nitrogen gas product stream and further comprising an oxygen heater for heating the oxygen gas product stream using the heated nitrogen gas product stream.

13. The system of claim 12, further comprising a second syngas heat exchanger for reheating the nitrogen gas product stream using the syngas stream.

14. The system of claim 9, wherein the syngas cooler is a syngas heat exchanger for cooling the syngas using the oxygen gas product stream.

15. A method for increasing power generated by an integrated gasification combined cycle system comprising the steps of:
producing a nitrogen gas product stream and an oxygen gas product stream using an air separation unit;
feeding the oxygen gas product stream to a gasifier;
producing a syngas stream in the gasifier using the oxygen gas product stream and coal; and
expanding at least a portion of the nitrogen gas product stream apart from the syngas stream using a turbine to produce power.
